(19) United States
(12) Patent Application Publication
(10) Pub. No.: US 2018/0108947 A9
(43) Pub. Date: Apr. 19, 2018

(54) ELECTROLYTE AND LITHIUM-ION BATTERY CONTAINING THE SAME

(71) Applicant: Ningde Amperex Technology Ltd., Ningde (CN)

(72) Inventor: Ruirui ZHUANG, Ningde (CN)

(73) Assignee: Ningde Amperex Technology Ltd., Ningde (CN)

(21) Appl. No.: 15/014,365

(22) Filed: Feb. 3, 2016

(30) Foreign Application Priority Data
Oct. 20, 2015 (CN) 201510683294.7

(51) Int. Cl. H01M 10/0569; H01M 10/0525; H01M 10/0568; H01M 10/0567; H01M 4/131; H01M 4/133; H01M 4/525; H01M 4/587; H01M 4/62; H01M 4/66

(52) U.S. Cl. CPC H01M 10/0569; H01M 10/0525; H01M 10/0568; H01M 10/0567; H01M 4/131; H01M 4/133; H01M 2004/027; H01M 4/587; H01M 4/622; H01M 4/623; H01M 4/625; H01M 4/661; H01M 4/525

(57) ABSTRACT

The present application is related to an electrolyte and a lithium-ion battery containing the same, wherein the electrolyte comprises lithium salt, a non-aqueous organic solvent and additives, the non-aqueous organic solvent comprising a carboxylate compound, and the additives comprising a fluoro-ether compound and a dinitrile compound comprising an ether bond. The electrolyte applied to the lithium-ion battery, particularly to an irregular-shaped lithium-ion battery, can improve the high temperature storage performance, the high temperature cycle life performance and the rate performances of the lithium-ion battery.

### TECHNICAL FIELD

The present disclosure is related to the technical field of lithium-ion batteries, particularly an electrolyte and a lithium-ion battery containing the electrolyte.

### BACKGROUND

The wettability of electrolytic solutions is very important for battery design. Normally, it is desirable that the solvent and liquid electrolyte can be absorbed by the hydrophilic surface of the anode materials, but they are incompatible by the hydrophobic surface of the materials such as polyolefin and carbon anode. At present, a mixed solvent of cyclic carbonate and chain carbonate as a non-aqueous organic solvent is commonly employed in the electrolyte of the lithium-ion battery. However, both the cyclic carbonate and chain carbonate are proton inert solvents having relatively high viscosity and large surface tension, so that affinity interaction between the electrolyte and separator materials is small, and the separator materials are hardly wetted by the electrolyte. Thus, the electrolyte has poor wettabilty for the separator. Furthermore, the electrolyte also has poor wettability to the materials such as the carbon anode, which causes the contact resistance between the electrode materials and the electrolyte to be relatively large and impacts the utilization rate of the materials, so it is not beneficial for the battery capacity to be fully fulfilled.

At present, there is nearly no regular square space left in mobile devices for the battery to be placed, and other electric devices often have an irregular ladder-like distribution. In light of this, an irregular-shaped battery is capable of fully utilizing the irregular room in devices to improve the capacity of the battery, so there might be a big development space for the irregular-shaped battery in the future market. However, poor wettability of the electrolyte appears to be more serious due to an irregular shape of the battery.

Therefore, it is indeed essential to develop an electrolyte having good wettability for a lithium-ion battery, especially for an irregular-shaped lithium-ion battery, as well as an irregular-shaped lithium-ion battery containing the electrolyte, so as to enable the lithium-ion battery, particularly the irregular-shaped lithium-ion battery, to possess excellent performance, such as cycle life performance, high temperature storage performance, low temperature discharge performance, and rate performance.

### SUMMARY

For solving the problem, through the study with keen determination, the applicant found that the electrolyte comprising carboxylate compounds, fluoroether compounds and dinitrile compounds comprising ether bonds, after being applied to the lithium-ion battery, is capable of improving the high temperature storage performance, high temperature cycle life performance and rate performance of the lithium-ion battery, and thereby the present disclosure herein comes into being.

One object of the disclosure is to provide an electrolyte comprising lithium salt, a non-aqueous organic solvent and additives, the non-aqueous organic solvent comprising a carboxylate compound, and the additive comprising a fluoro-ether compound and a dinitrile compound comprising an ether bond.

Another object of the disclosure is to provide a lithium-ion battery comprising a cathode sheet containing a positive active material, an anode sheet containing a negative active material, a lithium battery separator and the electrolyte provided in the disclosure.

Because the electrolyte provided by this disclosure comprises carboxylate compounds, fluoroether compounds and dinitrile compounds with ether bonds, so its application to the lithium-ion battery, particularly to the irregular-shaped battery, improves the high temperature storage performance, high temperature cycle life performance and rate performance of the lithium-ion battery, and particularly improves the storage performance and cycle life performance of the lithium-ion battery at the high temperature and voltage, as well as the rate performance of the lithium-ion batter at a high voltage.

### DETAILED DESCRIPTION OF THE EMBODIMENTS

The advantages and disadvantages of the invention will become clearer and more explicit along with the further detailed explanations for the present invention as below.

One object of the disclosure is to provide an electrolyte comprising lithium salt, a non-aqueous organic solvent and additives, the non-aqueous organic solvent comprising a carboxylate compound, and the additive comprising a fluoro-ether compound and a dinitrile compound comprising an ether bond.

In the electrolyte, the carboxylate compounds can be selected according to practical needs, such as chain carboxylate compounds, and cyclic carboxylate compounds. Preferably, the carboxylate compounds are selected from one or more of compounds represented in the following formulas I, II, III and IV:

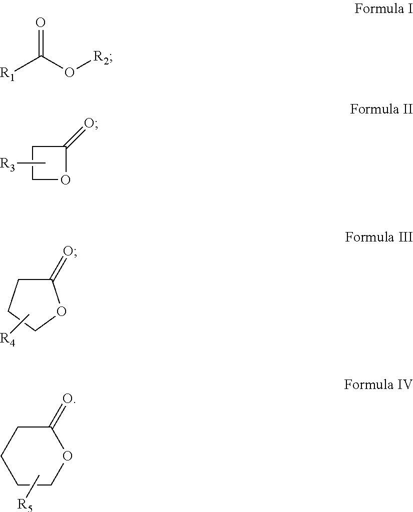

In formulas II, III and IV, the number of the substituent groups in the ring of the carboxylate is one, and the location of the substitute group is selectable according to the reasonable cases and is capable of being bond linked with any carbon atom in the ring.

In formulas I, II, III and IV, R₁, R₂, R₃, R₄, and R₅ are respectively selected from one of a hydrogen atom, a halogen atom, a cyanogroup, an alkyl having 1˜20 carbon atom(s), an alkenyl having 2˜20 carbon atoms, an aryl having 6˜26 carbon atoms, a group containing oxygen atoms in the said alkyl having 1˜20 carbon atom(s), the said alkenyl having 2˜20 carbon atoms and the said aryl having 6˜26 carbon atoms, and a group formed by substituting the alky having 1˜20 carbon atom(s), the alkenyl having 2˜20 carbon atoms and the aryl group 6˜26 carbon atoms with the halogen atom or the cyanogroup, wherein the halogen atom is F, Cl and Br, and neither R₁ nor R₂ is a hydrogen atom, a halogen atom or a cyano group.

As for the alkyl having 1˜20 carbon atoms in formulas I, II, III and IV, the specific kinds of alkylare not limited and are selectable according to practical needs, such as a chain alkyl or a naphthenic group, wherein the chain alkane further comprises a linear chain alkyl and a branched alkyl; and further the naphthenic group may or may not contain substituent groups. The lower limiting number of the carbon atoms of the alkyl is preferably 1, 2, 3 or 5, and the upper limiting number is preferably 3, 4, 5, 6, 7, 8 ,10, 12 or 16.

Preferably, the alkyl having 1˜10 carbon atom(s) is selected; further preferably, the chain alkyl having 1˜6 carbon atom(s) and the naphthenic group having 3˜8 carbon atoms are selected; and more preferably, the chain alkyl having 1˜4 carbon atom(s) and the naphthenic group having 5˜7 carbon atoms are selected.

The specific examples of the alkyl are as follows: methyl, ethyl, n-propyl, isopropyl, cyclopropyl, n-butyl, isobutyl, sec-butyl, tertiary butyl cyclobutyl, n-amyl, isoamyl, tertiary pentyl, neopentyl, cyclopentyl, 2,2-dimethyl propyl, 1-ethyl propyl, 1-methylbutyl, 2-methylbutyl, n-hexyl, isohesyl, 2-hexyl, 3-hexyl, cyclohexyl, 2-methylamyl, 3-methylamyl, 1,1,2-trimethylpropyl, 3,3-dimethylbutyl, n-heptyl, 2-heptyl, 3-heptyl, 2-methylhexyl, 3-methylhexyl, 4-methylhexyl, isoheptyl, cycloheptyl, n-octyl, cyclooctyl, nonyl, decyl, hendecyl, dodecyl, tridecyl, myristyl, pentadecane alkyl, cetyl, heptadecane alkyl, octadecyl, nonadecane and eicosyl.

As for the alkenyl having 2˜20 carbon atoms in formulas I, II, III and IV, the specific kinds of alkenyl group are not limited and are selectable according to practical needs, such as cyclic alkenyl and chain alkenyl. When the alkenyl is a cyclic alkenyl, its ring contains other substituent groups such as alkyl and/or alkenyl. Furthermore, the number and location of the double bonds in the alkenyl are not specifically limited, and the alkenyl with a desired structure can be selected according to practical cases. For example, the number of double bonds can be 1, 2, 3 or 4. The lower limiting number of the carbon atoms of the alkenyl is preferably 2, 3, 4 or 5, and the upper limiting number is preferably 3, 4, 5, 6, 7, 8 ,10, 12, 16 or 18.

In the preferable embodiments, the alkenyl having 2˜10 carbon atoms is selected. Further preferably, the alkenyl having 2˜6 carbon atoms is selected. More preferably, the alkenyl having 2˜5 carbon atoms is selected.

The specific examples of the alkenyl are as follows: vinyl, allyl, isopropenyl, 1-butenyl, 2-butenyl, 2-methyl-2-allyl, 1-methyl-2-allyl, 2-methyl allyl, pentenyl, 1-hexenyl, 3,3-dimethyl-1-butenyl, 2-heptenyl, 1-octylene, cyclobutene group, cyclohexenyl, cycloheptene group, and cyclooctene group.

As for the aryl having 6˜26 carbon atoms in formulas I, II, III and IV, the specific kinds of aryl are not limited and are selectable according to practical needs, for example, phenyl, benzene alkyl, aryl containing at least one phenyl such as xenyl, and polycyclic aromatic hydrocarbon such as naphthalene, anthracene and luxuriant, wherein xenyl and polycyclic aromatic hydrocarbon can also be linked with other substituent groups such as alkyl or alkenyl. The upper limiting number of the carbon atoms of the aryl is preferably 7, 8, 9, 10, 12, 14, 16, 18, 20 or 22, and the lower limiting number is preferably 6, 7, 8 or 9.

In the preferable embodiments, the aryl having 6˜16 carbon atoms is selected. Further preferably, the aryl having 6˜14 carbon atoms is selected. More preferably, the aryl having 6˜9 carbon atoms is selected.

The specific examples of the aryl are as follows: phenyl, benzyl, xenyl, p-methylphenyl, o-methylphenyl, m-methylphenyl, p-ethylphenyl, m-ethylphenyl, o-ethylphenyl, 3,5-xylyl, 2,6-dimethylphenyl, 3,5-diethylphenyl, 2,6-diethylphenyl, 3,5-diisopropylphenyl, 2,6-diisopropylphenyl, 3,5-di-n-proplyphenyl, 2,6-di-n-proplyphenyl, 3,5-di-n-butyphenyl, 2,6-di-n-butyphenyl, 3,5-diisobutylphenyl, 2,6-diisobutylphenyl, 3,5-di-t-butylphenyl, 2,6-di-t-butylphenyl, trityl, 1-naphthyl, and 2-naphthyl.

In formulas I, II, III and IV, when the alkyl having 1˜20 carbon atom(s) contains oxygen atoms, the number and location of the oxygen atoms are not specifically limited, wherein the number of the oxygen atoms can be 1, 2, 3 or 4. Particularly, alkoxy having 1˜20 carbon atoms and alkyl ether group having 2˜20 carbon atoms are selected. Furthermore, when the alkyl having 1˜20 carbon atom(s) contains oxygen atoms, the lower limiting number of the carbon atoms is preferably 1, 2, 3, 4 or 5 and the upper limiting number of carbon atoms is preferably 3, 4, 5, 6, 7, 8, 10, 12, 16 or 18.

Preferably, alkoxy groups having 1˜10 carbon atom(s) and alkyl ether groups having 2˜10 carbon atoms are selected; more preferably, alkoxy groups having 1˜6 carbon atom(s) and alkyl ether groups having 2˜6 carbon atoms are selected; and further preferably, alkoxy groups having 1˜4 carbon atom(s) and alkylether groups having 2˜5 carbon atoms are selected.

The specific examples of the alkoxy and alkyl ether group are as follows: methoxyl, ethyoxyl, n-propoxy, isopropoxy, n-butoxy, sec-butoxy, tert-butoxy, n-pentyloxy, iso-pentyloxy, tert-pentyloxy, neopentoxy, 2,3-dimethyl propoxy, 1-ehylpropoxy, 1-methylbutyloxyl, n-hexyloxy, isohexyloxy, 1,1,2-trimethylpropoxy, n-heptyloxyl, n-octyloxyl, cyclopropxy, cyclobutoxy, cyclopentyloxy, cyclohexyloxy, cycloheptyloxy, cyclooctyloxy, methoxylmethyl, oxethylethyl, oxethylmethyl, 3-n-propoxyn-propyl, n-propoxymethyl, 1-n-propoxyethyl, 1-n-propoxyisopropyl, n-butoxymethyl, 1-n-butoxyethyl, 2-n-butoxy-n-propyl, tert-butoxymethyl, 2-butoxyethyl, 2-butoxynpropyl, 2-butyoxyisopropyl, 3-butoxyn-ethyl, 4-n-pentyloxyisoamyl, 2-n-pentyloxy cyclopentyl, 2-cyclopentyloxyl cyclopentyl, 3-n-hexyloxy-n-hexyl, and 4-cyclohexyloxycyclohexyl.

In formulas I, II, III and IV, when the alkenyl having 2˜20 carbon atoms contains oxygen atoms, the number and location of the oxygen atoms are not specifically limited, wherein the number of the oxygen atoms can be 1, 2, 3 or 4. Particularly, alkeneoxy group having 1˜20 carbon atom(s) and alkenether having 2˜20 carbon atoms are selected. Furthermore, when the alkenyl having 2˜20 carbon atoms contains oxygen atoms, the lower limiting number of the carbon atoms is preferably 2, 3, 4 or 5 and the upper limiting number of carbon atoms is preferably 3, 4, 5, 6, 7, 8, 10, 12, 16 or 18.

Preferably, alkeneoxy groups having 2˜10 carbon atoms and alkenether groups having 3˜10 carbon atoms are selected; more preferably, alkeneoxy groups having 2˜8 carbon atoms and alkenether groups having 3˜8 carbon atoms are selected; and further preferably, alkeneoxy groups having 2˜6 carbon atoms and alkenether groups having 3˜6 carbon atoms are selected.

The specific examples of the alkoxy and alkyl ether are as follows: allyloxy, butenyloxy, pentenyloxy, hexenyloxy, heptenyloxy, alkenyloxy, 1-methoxylvinyl, 2-ethyoxylvinyl, 2-methoxylvinyl, 2-methyoxy-2-allyl, 1-ethyoxy-2-allyl, 2-ethyleneoxylvinyl, 1-ethyleneoxy-l-methylvinyl, and 2-ethyleneoxy-1-methylvinyl.

In formulas I, II, III and IV, when the aryl having 6˜26 carbon atoms contains oxygen atoms, the number and location of the oxygen atoms are not specifically limited, wherein the number of the oxygen atoms can be 1, 2, 3 or 4, preferably 1 or 2. Particularly, aryloxy having 6˜26 carbon atoms and arylether having 7˜26 carbon atoms are selected, wherein the kinds of aryl which is linked with the oxygen is not specifically limited and are selectable according to practical needs, for example, phenyl, phenylalkyl, aryl containing at least one phenyl such as xenyl and polycyclic aromatic hydrocarbon. In the aryloxy group, the lower limiting number of the carbon atoms of aryloxy is preferably 6, 7, 8 or 9, and the upper limiting number of carbon atoms of aryloxy cyano group is preferably 7, 8, 9,10, 12,14, 16 or18.

Preferably, aryloxy having 6˜16 carbon atoms and aryl ether having 7˜16 carbon atoms are selected; more preferably, aryloxy having 6˜14 carbon atoms and aryl ether having 7˜14 carbon atoms are selected; and further preferably, aryloxy having 6˜10 carbon atoms and aryl ether having 7˜10 carbon atoms are selected.

The specific examples of the aryloxy are as follows: phenoxyl, benxyloxy, 4-methylphenoxy, 3-methylphenoxy, 2-methylphenoxy, 4-ethylphenoxy, 3-ethylphenoxy, 2-ethylphenoxy, 4-n-propylphenoxy, 3-n-propylphenoxy, 2-n-propylphenoxyl, 4-isopropylphenoxy, 3-isopropylphenoxy, 2-isopropylphenoxy, 4-n-butylphenoxy, 3-n-butylphenoxy, 2-n-butylphenoxy, 4-isobutylphenoxy, 3-isobutylphenoxy, 2-isobutylphenoxy, 4-tert-butylphenoxy, 3-tert-butylphenoxyl, 2-tert-butylphenoxy, 3,5-dimethylphenox, 2,6-dimethylphenoxy, 3,5-diethylphenoxy, 2,6-diethylphenoxy, 3,5-di-n-propoylphenoxy, 2,6-n-proppoylmethyl phenoxy, 3,5-di-isopropylphenoxy, 2,6-diisopropylphenoxy, 3,5-di-n-butylphenoxy, 2,6-di-n-butylphenoxy, 4-methylbenzyloxy, 3-methylbenzyloxy, 2-methylbenzyloxy, 4-ethylbenzyloxy, 3-ethylbenzyloxy, 2-methylbenzyloxy, 3,5-diisoproplybenzyloxy, 2,6-diisoproplybenzyloxy, 1-naphthoxy, 2-naphthoxy, methoxyphenyl, ethoxyphenyl, phenoxymethyl, phenoxyethyl, o-methoxyphenmethyl, m-methoxyphenmethyl, p-methoxyphenmethy, o-ethoxyphenmethyl, m-ethoxyphenmethyl, p-ethoxyphenmethyl, o-phenoxyphenyl, m-phenoxyphenyl, and p-phenoxyphenyl.

In formulas I, II, III and IV, the halogenated alkyl having 1˜20 carbon atom(s), halogenated alkenyl having 2˜20 carbon atoms, and halogenated aryl having 6˜26 carbon atoms are correspondingly formed after the alkyl having 1˜20 carbon atom(s), alkeny having 2˜20 carbon atoms and arylhaving 6˜26 carbon atoms are substituted with halogen atoms, wherein the haogen atoms are F, Cl and Br. As for the formed halogenated groups, there is no special limitation for the number and location of the halogen atoms for substitution, and whether the halogen atoms substitute some or all of the hydrogen atoms in the groups is slelectable according to practical needs. For example, the number of the halogen atoms is 1, 2, 3 or 4. When the halogen atoms for substitution are more than 2, the kinds of the halogen atoms may be the same or completely different, or partially the same.

Preferably, the halogenated alkyl having 1˜10 carbon atom(s), halogenated alkenyl having 2˜10 carbon atoms, and halogenated aryl having 6˜16 carbon atoms are selected; further preferably, the halogenated chain alkyl having 1˜6 carbon atom(s), halogenated naphthenic group having 3˜8 carbon atoms, halogenated alkenyl having 2-6 carbon atoms and halogenated aryl having 6˜14 carbon atoms are selected; more preferably, the halogenated chain alkyl group having 1˜4 carbon atom(s), halogenated naphthenic group having 5˜7 carbon atoms, halogenated alkenyl having 2˜5 carbon atoms and halogenated aryl having 6˜10 carbon atoms are selected.

Particularly, when the groups are substituted with fluorine atoms, the formed groups are specifically as below: fluoromethyl, 2-fluoroethyl, 1-fluoroethyl, 3-fluoropropyl, 2-fluoroisopropyl, 4-fluorobutyl, 3-fluorosec-butyl, 2-fluorosec-butyl, 5-fluoroamyl, 1-fluoron-amyl, 4-fluoroisoamyl, 3-fluoroisoamyl, 1-fluoro-2,2-dimethylpropy, 4-fluroro-l-methylbutyl, 6-fluoro-n-hexyl, 4-fluoroisohesyl, 7-fluoro-n-heptyl, 8-fluoro-n-octyl, 1-fluorovinyl, 3-fluoroallyl, 2-fluoroallyl, 1-fluoromethylisopropenyl, 2-fluoroisopropenyl, 4-fluoro-l-butenyl, 4-fluoro-2-butenyl, 3-fluoro-2-methylpropenyl, 5-fluoro-2-pentenyl, 6-fluoro-2-hexenyl, 6-fluoro-4-hexenyl, 4-fluoro-3,3-dimethyl-l-butenyl, 7-fluoro-l -heptenyl, 7-fluoro-2-heptenyl, 8-fluoro-l-octylenyl, 8-fluoro-2-octylenyl, 8-fluoro-6-octylenyl, o-fluorophenyl, p-fluorophenyl, m-fluorophenyl, 4-fluoromethylphenyl, 4-fluoroethylphenyl, 2-fluoroethylphenyl, 3,5-difluorophenyl, 2,6-difluorophenyl, 2,6-difluoromethylphenyl, 3,5-difluoroethylphenyl, and 2-fluoro-l-naphthyl. In these embodiments, F can be subsituted by Cl and/or Br.

In formulas I, II, III and IV, the alkyl cyano having 2˜21 carbon atoms, the alkenyl cyano having 3˜21 carbon atoms, and the aryl cyanogroup having 7˜27 carbon atoms are correspondingly formed after the alkyl having 1˜20 carbon atom(s), alkeny having 2˜20 carbon atoms and aryl having 6˜26 carbon atoms are substituted with cyano group. In the formed substituted groups containing cyanogroup, there is no special limitation for the number and location of the cyano for substitution, and the hydrogen atoms in the alkyl, alkenyl or aryl can be partially or completely substituted according to practical needs. For example, the number of the cyano groups can be 1, 2, 3 or 4.

Preferably, the alkyl cyano having 2˜10 carbon atoms, the alkenyl cyano having 3˜10 carbon atoms, and the aryl cyano having 7˜16 carbon atoms are selected; more preferably, the chain alkyl cyano group having 2˜6 carbon atoms, the naphthene cyano having 4˜8 carbon atoms, the alkenyl cyano group having 3˜6 carbon atoms, and the aryl cyano having 7˜14 carbon atoms are selected; further preferably, the chain alkyl cyano having 3˜5 carbon atoms, the naphthene cyano having 4˜7 carbon atoms, the alkenyl cyano group having 3˜5 carbon atoms, and the aryl cyano having 7˜10 carbon atoms are selected.

The specific examples of alkyl cyano are as follows: cyanomethyl, 2-cyanoethyl, 1-cyanoethyl, 3-cyanopropyl, 2-cyanoisopropyl, 4-cyanobutyl, 3-cyanosec-butyl, 2-cyanosec-butyl, 1-cyanosec-butyl, tert-butylcyano, 5-cyanoamyl, 4-cyanoamyl, 3-cyanoamyl, 2-cyanoamyl, 1-cyanoamyl, 4-cyanosioamyl, 3-cyanosioamyl, 2-cyanosioamyl, 1-cyanosioamyl, 1-cyano-2,2-dimethylpropyl, 3-cyano-2,2-dimethypropyl, 3-cyano-l-ethylpropyl,4-cyano-l-methylbutyl, 6-cyano-n-hexyl, 4-cyano-isohesyl, 3-cyano-1,1,2-trimethylpropyl, 7-cyano-n-heptyl, 8-cyano-n-octyl, 2-cyanomethyl-4-cyanobutyl, 2-cyanocyclopropyl, 2-cyanocyclobutyl, 3-cyanocyclopentyl, and 4-cyanomethylcyclohexyl.

The specific examples of alkenylcyano group are as follows: 2-cyanovinyl, 1-cyanovinyl, 3-cyanoallyl, 2-cyanoallyl, 1-cyanoallyl, 1-cyanomethylisoallyl, 2-cyanoisoallyl, 4-cyano-1-butenyl, 3-cyano-1-butenyl, 2-cyano-2-butenyl, 1-cyano-2-butenyl, 2-cyanomethylallyl, 1-cyano-2-methylallyl, 3-cyano-l-methylallyl, 1-cyanomethylallyl, 3-cyano-2-methylallayl, 2-cyanomethylallyl, 5-cyano-2-pentenyl, 6-cyano-2-hexylenyl, 6-cyano-l-hexylenyl, 6-cyano-4-hexylenyl, 3,3-dicyanomethyl-1-butenyl, 4-cyano-3,3-dimethyl-1-butenyl, 7-cyano-l-heptenyl, 7-cyano-2-heptenyl, 8-cyano-l-octylenyl, 8-cyano-2-octylenyl, 2-cyanomethyl-3-cyclopentenyl, and 4-cyano-2-cyclohexenyl.

The specific examples of arylcyano group are as follows: 4-cyanophenyl, 2-cyanophenyl, 3-cyanophenyl, 4-cyanomethylphenyl, 2-cyanomethylphenyl, 3-cyanomethylphenyl, 4-cyanoethylphenyl, 2-cyanoethylphenyl, 3-cyanoethylphenyl, 3,5-dicyanophenyl, 2,6-dicyanophenyl, 4-cyanobenzyl, 3-cyanobenzyl, 2-cyanobenzyl, and 2-cyano-1-naphthyl.

The specific examples of the chain carboxylate represented by formula I are as below: methyl acetate, propyl acetate, 1-fluoropropyl acetate (as shown in formula a), 1-cyanopropyl acetate (as shown in formula b), ethyl propionate ethyl valerate, ethyl isovalerate, and propyl propionate, butyl propionate, isobutyl propionate, butyl butyrate, butly isobutyrate, amyl butyrate, isoamyl butyrate, amyl propionate, isoamyl propionate, ethyl propionate, ethyl isopropionate, ethyl butyrate, ethyl isobutyrate, ethyl valerate, propyl valerate, propyl isovalerate, and ethyl isovalerate.

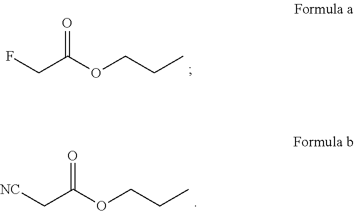

The specific examples of cyclic carboxylic ester represented by formulas I, II, III and IV are as follows:

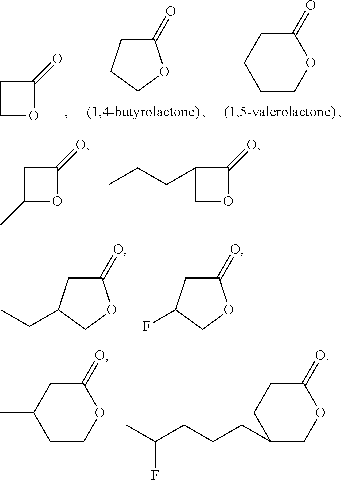

Preferably, the content of the carboxylic ester compound in the electrolyte takes 1˜70% in the total weight of the electrolyte, preferably, 10˜30%.

The fluoro-ester compound in the electrolyte is preferably selected from one or more of the compounds represented by formula V and VI:

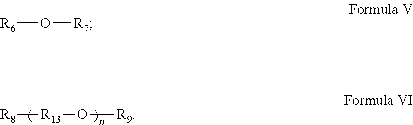

In formula V, R₆ and R₇ are respectively selected from one of a fluoro alkyl having 1˜20 carbon atom(s), a fluoro alkenyl having 2˜20 carbon atoms and a fluoro aryl having 6˜22 carbon atoms.

In formula VI, R₈ and R₉ are respectively selected from one of an alkyl having 1˜10 carbon atom(s), an alkenyl having 2˜10 carbon atoms, an aryl having 6˜14 carbon atoms, a fluoroalkyl having 1˜10 carbon atom(s), a fluoroalkenyl group having 2˜10 carbon atoms and a fluoroaryl having 6˜14 carbon atoms; R₁₃ is selected from one of a fluoroalkylene having 1˜20 carbon atom(s), a fluoroalkenylene having 2˜20 carbon atoms and a fluoroarylene having 6˜22 carbon atoms; and n is an integer between 2˜10, n is preferably 2˜6, and more preferably 2˜4.

As for the fluoro alkyl having 1˜20 carbon atom(s) in formula V, wherein the number and location of the fluorine atoms in fluoro alkyl for substitution are not specifically limited, and the hydrogen atom in the alkyl can be substituted partially or completely according to practical needs. Form example, the number of fluorine atoms can be 1, 2, 3 or 4. The lower limiting number of the carbon atoms of the fluoro alkyl is preferably 1, 2 or 3, and the upper limiting number is preferably 3, 4, 5, 6, 7, 8 ,10, 12, 16 or 18.

Preferably, fluoro alkyl having 1˜10 carbon atom(s) is selected; further preferably, fluoro chain alkyl having 1˜6 carbon atom(s) and fluoro naphthene having 3˜8 carbon atoms are selected; more preferably, fluoro chain alkyl having 1˜4 carbon atom(s) and fluoro naphthene having 5˜7 carbon atoms are selected.

The specific examples of fluoroakyl are as below: methylfluoro, difluoromethyl, trifluoromethyl, 1-fluoroethyl, 1,2-difluoroethyl, 2-fluoron-propyl, 2,2,2-trifluoroethyl, 2,2-difluoro-n-propyl, 1-fluoroisopropyl, fluorocyclopropyl, 1-fluoron-butyl, 2-fluoroisobutyl, fluorocyclobutyl, 1-fluoron-amyl, 2-fluoron-amyl, 1-fluoroisoamyl, 2,2-difluoromethylpropyl, fluorocyclopentyl, 3-fluoro-2,2-dimethypropyl,1-fluoro-l-ethylproply, 1-fluoro-l-methylbutyl, 2-fluoro-2-methylbutyl, 2-fluoron-hexyl, fluorocyclohexyl, 2-fluoromethylamyl, 3-fluoro-3-methylamyl, 2-fluoro-1,1,2-trimethylpropyl, 4-fluoro-3,3-dimethlybutyle, 2-fluoron-heptyl, 2-fluorocyclohexyl, perfluor 1-ethyl-thrimethylpropy, perfluorethyl, 1,1,2,2-tetrafluoroethyl, 2-methyl -2,2,3,4,4,4-hexaflurobutyl, 3,3,3-trifluoropropyl, and 2,2-difluoroethyl.

As for the fluoro alkenyl having 2˜20 carbon atoms in formula VI, there is no special limitation for the substituted alkenyl, such as chain alkenyl or cyclic alkenyl, wherein the chain alkenyl can be divided into linear alkenylp and branched alkenyl. In fluoro alkenyl, the number of double bonds is 1, 2, 3 or 4, preferably 1 or 2. In addition, the fluorine atoms subsutite the hydrogen atoms in the alkenyl group partially or completely, for example the number of fluorine atoms is 1, 2, 3 or 4. The lower limiting number of the carbon atoms in fluoro alkenyl is preferably 3, 4 or 5, and the upper limiting number of the carbon atoms is preferably 3, 4, 5, 6, 7, 8, 10, 12, 14, 16 or 18.

Preferably, fluoro alkenyl having 2˜10 carbon atoms is selected; further preferably, fluoro alkenyl having 2˜6 carbon atoms is selected; more preferably, fluoroalkenyl having 2˜5 carbon atoms is selected.

The specific examples of fluoroalkenyl group are as below: 2-fluorovinyl, 1-fluorovinyl, 3-fluoroallyl, 2-fluoroallyl, 1-fluoroallyl, 2-fluoroc-2-cyclopropyenyl, 1-fluoromethylisopropenyl, 2-fluoroisopropenyl, 4-fluoro-1-butenyl, 3-fluoro-1-butenyl, 2-fluoro-1-butenyl, 2-fluoro-2-cyclobutene, 1-fluoro-l-butenyl, 4-fluoro-2-butenyl, 3-fluoro-2-butenyl, 2-fluoro-2-butenyl, 1-fluoro-2-butenyl, 2-fluoromethylpropennyl, 5-fluoro -2-pentenyl, 5-fluoro-3-pentenyl, 5-fluoro-2-cyclopentenyl, 6-fluoro -2-hexenyl, 6-fluoro-3-hexenyl, 4-fluoro-2-cyclohexenyl, 3, 3-difluormethyl-1-butenyl, 4-fluoro-3 ,3-dimethyl-l-butenyl, 7-fluoro -1-heptenyl, 7-fluoro-2-heptenyl, 8-fluoro-l-octylene, 8-fluoro-2-octylene, 8-fluoro-3-octylene, 8-fluoro-4-octylene, 8-fluoro-5-octylene, 8-fluoro-6-octylene, and 8-fluoro-7-octylene.

As for the fluoro aryl having 6˜22 carbon atoms in formula VI, the number and location of the fluorine atoms in haogenate substituted aryl for substitution are not specifically limited, and the hydrogen atom in the aryl can be substituted partially or completely according to practical needs. Form example, the number of fluorine atoms can be 1, 2, 3 or 4. The lower limiting number of the carbon atoms of the fluoroaryl is preferably 6, 7, 8 or 9, and the upper limiting number is preferably 7, 8, 9, 10, 12, 14, 16, 18 or 20.

Preferably, fluoroaryl having 6˜16 carbon atoms is selected; further preferably, fluoroaryl having 6˜14 carbon atoms is selected; more preferably, fluoroaryl group having 6˜10 carbon atoms is selected.

The specific examples of fluoroaryl are as follows: 2-forophenyul, 3-forophenyul, 4-forophenyul, 2-forophenyul, 2-fluoro-4-methylphenyl, 3-fluoro-4-methylphenyl, 2,3-difluoro-4-methylphenyl, 3,5-difluoro-4-methylphenyl, 2,6-difluoro-4-methylphenyl, p-trifluoromethylphenyl, o-trifluoromethylphenyl, m-trifluoromethylphenyl, 2-fluorobenzyl, 3-fluorobenzyl, 4-fluorobenzyl, 3,5-difluorobenzyl, 2,6-difluorobenzyl, 2-fluoro-4-ethylphenyl, 3-fluoro-4-ethylphenyl, 2-fluoro-4-n-propylphenyl, 3-fluoro-4-n-propylphenyl, 2-fluoro-4-isopropylphenyl, 3-fluoro-4-isopropylphenyl, 3, 5-difluoro-4-isopropyl phenyl, 2,6-difluoro-4-isopropylphenyl, and 2-fluoro-l-naphthyl.

As for the alkyl having 1˜10 carbon atoms in formula VI, the kinds of alkyl are not specifically limited, and are selectable according to practical needs, such as the chain alkyl and naphthene, wherein the chain alkane group further comprises the linear alkyl and branched alkyl, and the naphthene may have or not have the substituent groups. In the alkyl, the lower limiting number of the carbon atoms in the alkyl is preferably 1, 3 or 4, and the upper limiting number of the carbon atoms in the alkyl is 3, 4, 5, 6, 7, 8 or 10.

Preferably, the alkyl having 1˜8 carbon atoms is selected; further preferably, chain alkyl having 1˜6 carbon atoms and naphthene having 3˜8 carbon atoms are selected; more preferably, chain alkyl having 1˜4 carbon atoms and naphthene having 5˜7 carbon atoms are selected. The examples of the alkyl are the same to those of the alkyl mentioned previously, but not limited thereto, and the desired alkyl can be obtained through rearranging the listed examples of the alkyl.

As for the alkenyl having 2˜10 carbon atoms in formula VI, the kinds of the alkenyl groups are not specifically limited, and are selectable according to practical needs, for example cyclic alkenyl and chain alkenyl, wherein when the alkenyl is a chain alkenyl, it can be substituted by other substituent groups, such as alkyl group and/or alkenyl group. In addition, the number and location of the double bonds in the alkenyl are not specifically limited, and it is possible to select the alkenyl with desired structure according to practical needs. Particuarlly, the number of double bonds are 1, 2, 3 or 4. In the alkenyl, the lower limiting number of carbon atoms in the alkenyl may be 2, 3, 4 or 5, and the upper limiting number of the carbon atoms of the unsaturated hydrogen group is 3,4, 5, 6, 7, 8 or 10.

Preferably, the alkenyl having 2˜8 carbon atoms is selected; further preferably, the alkenyl having 2˜6 carbon atoms is selected; more preferably, the alkenyl having 2˜5 carbon atoms is selected. The examples of the alkenyl are the same to those of the alkenyl mentioned previously, but not limited thereto, and the desired alkenyl can be obtained through rearranging the listed examples of the alkenyl.

As for the aryl having 6˜14 carbon atoms in formula VI, the kinds of the aryl groups are not specifically limited, and are selectable according to practical needs, for example, phenyl, phenyl alkyl, aryl containing at least one phenyl such as xenyl, polycyclic aromatic hydrocarbon group such as naphthalene, anthracene and luxuriant, wherein the upper limiting number of the carbon atoms of the aryl is preferably 7, 8, 9, 10 or 12, and the lower limiting number of the carbon atoms in the aryl is preferably 6, 7, 8 or 9.

Preferably, the aryl having 6˜12 carbon atoms is selected; further preferably, the aryl having 6˜10 carbon atoms is selected; more preferably, the aryl having 6˜9 carbon atoms is selected. The examples of the aryl are the same to those of the aryl mentioned previously, but not limited thereto, and the desired aryl can be obtained through rearranging the listed examples of the aryl.

In the fluoroalkyl having 1˜10 carbon atoms, fluoroalkenyl having 2˜10 carbon atoms, and fluoroaryl having 6˜14 carbon atoms in formula VI, the number and location of the fluorine atoms for substitutions are not specifically limited, and the hydrogen atoms in the groups can be substituted partially or completely according to practical needs. For example, the number of the fluorine atoms can be 1, 2, 3 or 4 or more.

Preferably, fluoroalkyl having 1˜8 carbon atoms, fluoroalkenyl having 2˜8 carbon atoms, and fluoroaryl having 6˜12 carbon atoms are selected; further preferably, chain fluoroalkyl having 1˜6 carbon atoms, fluoro naphthentic having 3˜8 carbon atoms, fluoroalkenyl having 2˜6 carbon atoms and fluoroaryl having 6˜10 carbon atoms are selected; more preferably, fluoro chain alkyl having 1˜4 carbon atoms, fluoro naphthentic having 5˜7 carbon atoms, fluoroalkenyl having 2˜5 carbon atoms and fluoroaryl having 6˜9 carbon atoms are selected, wherein for the specific examples, the previous examples of fluoroalkyl, fluoroalkenyl and fluoroaryl can be referred to, but are not limited thereto, and can be reasonably rearranged based on said specific disclosure according to practical cases and requirements.

As for the fluoroalkylene having 1˜20 carbon atoms in formula VI, the substituted alkylene can be chain alkylene or cyclic alkylene. The lower limiting number of the carbon atoms of the fluoroalkylene is preferably 1, 2, 3 or 4, and the upper limiting number of the carbon atoms of the fluoroalkylene is preferably 3, 4, 6, 8, 10, 12 or 16.

Preferably, the fluoroalkylene having 1˜10 carbon atoms is selected; further preferably, the fluoro chain alkylene having 1˜6 carbon atoms and the fluoro cyclic alkylene having 3˜8 carbon atoms are selected; more preferably, the fluoro chain alkylene having 1˜4 carbon atoms and the fluoro cyclic alkylene having 5˜7 carbon atoms are selected.

The specific examples of fluoroalkylene are as below: fluoromethylene, difluoromethylene, fluoroethylidene, 1,2-difluoroethylidene, 2-fluoro-1,3-propylidene, 2,2-difluoror-1, 3-propylidene, 2-fluoromethyl-1,3-propyliden, 1, 3-difluoro-1,3-dimethylpropylidene, fluoromethyl-1,2-ethyl diene, 1,1-difluoromethylethylidene, 1,2-difluoro-1,2-dimethylethylidene, 1,4-difluororbutylidene, 1,2-difluorobutylidene, 1,3-difluorobutylidene, 1,5-difluoroamylidene, 1,2-difluoroamylidene, 1,3-difluoroamylidene, 1,4-difluoroamylidene, 1,2-difluorohexylidene, 1, 3-difluorohexylidene, 1,4-difluorohexylidene, 1,5-difluorohexylidene, 1,6-difluorohexylidene, and 1,1,4,4-tetrafluoromethylbutlidene.

As for the fluoroalkenylene having 2˜20 carbon atoms in formula VI, the kinds of the substituted alkenylene are not specifically limited, and are selectable according to practical needs, for example, chain alkenylene or cyclic alkenylene, wherein the cyclic alkenylene may be linked with other substituent groups, such as alkyl. In addition, the fluorine atom is selected to substitute the hydrogen atoms in the alkenylene partially or completely. In the fluoroalkenylene, the lower limiting number of carbon atoms in is preferably 2, 3, 4 and 5, and the upper limiting number of the carbon atoms is preferably 3,4, 5, 6, 7, 8 ,10, 12, 16 and 18.

Preferably, the fluoroalkenylene having 2˜10 carbon atoms is selected; further preferably, the fluoroalkenylene having 2˜8 carbon atoms is selected; more preferably, the fluoroalkenylene having 2˜6 carbon atoms is selected.

The specific examples of fluoroalkenylene are as follows: fluoro-1,2-ethenylidene, 1-fluoro-ethenylidene, 2-fluoro-1,3-propenylene, 3,3-difluoro-2-acrol, fluoromethyl-1,2-ethenylidene, 1-fluoroethyl -1,2-ethenylidene, 2-fluoro-1,4-butylidene-2-alkenyl, 4-fluoro-1,5-pentylene -2-alkenyl, 2-fluoro-1,6-hexylidene-3-alkenyl, 1,4-difluoro-1,4-cyclobutylidene-2-alkenyl, 2,3-difluoro-2-cyclopentenylene and 5,6-difluoro-2-cyclohexenylene.

As for the fluoroarylidene having 6˜22 carbon atoms in formula VI, the kinds of the substituted arylidene groups are not specifically limited, and are selectable according to practical needs, for example, phenylidene, phenylalkylene, arylidene comprising at least one phenyl such as biphenylene and polycyclic arylidene, wherein biphenylene and polycyclic arylidene can be linked with other substituent sheets, such as alkyl. In the fluoroarylidene, the upper limiting number of carbon atoms is preferably 7, 8, 9, 10, 12, 14, 16, 18 or 20, and the lower limiting number of the carbon atoms is preferably 6, 7, 8 or 9.

Preferably, the fluoroarylidene having 6˜16 carbon atoms is selected; further preferably, the fluoroarylidene having 6˜12 carbon atoms is selected; more preferably, the fluoroarylidene having 6˜9 carbon atoms is selected.

The specific examples of fluoroarylidene are as below: 3,4,5,6-tetrafluoro-1,2-phenylidene, phenyl fluroromethylene, p-isopropylphenylfluoromethylene, 2,3,4,5,6-pentafluorophenylmethylene, 1-phenyl-1-fluoro-1,2-ethylidene, 4-fluoro-1-methyl-2,3-phenylidene, and 1-(1,2-difluoroethyl) -2,3-phenylidene.

The specific examples of the fluoro-ether compounds are:

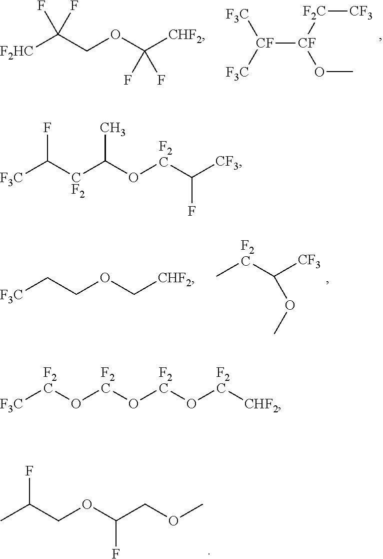

In the electrolyte, preferably, the content of the fluoro-ether compunds takes 0.01˜5% in the total weight of electrolyte, and further preferably, the content of the fluoro-ether compunds takes 0.1˜3% in the total weight of electrolyte.

In the electrolyte, the dinitrile compounds having ether bonds are one or more of the compounds represented by the following formula VII:

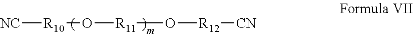

In formula VII, R₁₀, R₁₁ and R₁₂ are respectively selected from one of alkylene having carbon atoms 1˜10, alkenylene having carbon atoms 2˜10 and fluoroalkylene having carbon atoms 1˜10; and m is an integer between 1˜10, preferably 1˜5.

As for the alkylene having carbon atoms 1˜10 in formula VII, the alkylene may be chain alkylene or cyclic alkylene. In addition, the lower limiting number of carbon atoms in the alkylene is preferably 1, 2, 3 or 4, and the upper limiting number is preferably 3, 4, 6, 8 or 9.

Preferably, the alkylene having carbon atoms 1˜8 is selected; further preferably, chain alkylene having carbon atoms 1˜6 and the cyclic alkylene having 3˜8 carbon atoms are selected; more preferably, the chain alkylene having carbon atoms 1˜4 and the cyclic alkylene having 5˜7 carbon atoms are selected.

The specific examples of alkylene are as follows: methylene, 1,2-ethylidene, 1, 3-propylidene, 2-methyl-1, 3-propylidene, 1,3-dimethylpropylidene, 1-methyl-1,2-ethylidene, 1,1-dimethyethylidene, 1,2-dimethyehylidene, 1,4-butylidene, 1,5-pentylidene, 1,6-hexylidene, 1,1,4,4-tetramethylbutylidene, cyclopropylidene, 1,2-cyclopropylidene, 1,3-cyclobutylidene, cyclobutylidene, cyclohexylidene, 1,4-cyclohexylidene, 1,4-cycloheptyl, cycloheptyl, 1,5-cyclooctylidene and cyclooctylidene.

As for the alkenylene having 2˜10 carbon atoms in formula VII, the kinds of the alkenylene are not specifically limited, and are selectable according to practical needs, for example, cyclic alkenyl and chain alkenyl, wherein when the alkenylene is the cyclic alkenyl, it can be substituted by other substituent groups, such as alkyl and/or alkenyl. In addition, the number and location of the double bonds in the alkenyl are not specifically limited, and it is possible to select the alkenyl with desired structure according to practical needs. Particularly, the number of double bonds can be 1, 2, 3 or 4. In the alkenylene, the lower limiting number of carbon atoms is preferably 2, 3, 4 or 5, and the upper limiting number of the carbon atoms is preferably 3,4, 5, 6, 7, 8 or 9.

In preferable embodiments, the alkenylene having carbon atoms 2˜8 is selected; further preferably, the alkenylene having carbon atoms 2˜6 is selected; more preferably, the alkenylene having carbon atoms 2˜5 is selected.

The specific examples of alkenylene are as follows: 1,2-vinylidene, vinylidene, 1,3-propenylene, 2-propenylene, methyl-1,2-vinylidene, methyl-1,2-ethenylidene, 1,4-butylene-2-alkenyl, 1,5-pentamethylene-2-alkenyl, 1,6-hexylidene-3-alkenyl, 1,7-heptylene-3-alkenyl, 1,8-octylene-2-alkenyl, cyclobutenylene, 2-cyclopentenyl, 1,4-cyclohexylidene-2-alkenyl, 2-cycloheptenylidene, and 1,5-octylene -3-alkenyl.

As for the fluoroalkylene having 1˜10 carbon atoms in formula VII, the substituted alkylene can be chain alkylene or cyclic alkylene. In the fluoroalkylene, the lower limiting number of carbon atoms is preferably 1, 2, 3 or 4, and the upper limiting number of the carbon atoms is preferably 3, 4, 6, 8 or 9.

Preferably, the fluoroalkylene having carbon atoms 1˜8 is selected; further preferably, chain fluoroalkylene having carbon atoms 1˜6 and the cyclic fluoro cyclic alkylene having 3˜8 carbon atoms are selected; more preferably, chain fluoroalkylene group having carbon atoms 1˜4 and the fluoro cyclic alkylene having 5˜7 carbon atoms are selected. The examples of the fluoroalkylene are the same to those of the fluoroalkylene mentioned previously, but not limited thereto, and can be obtained through rearranging the listed examples.

The specific examples of dinitrile compound containing ether bonds are as follows:

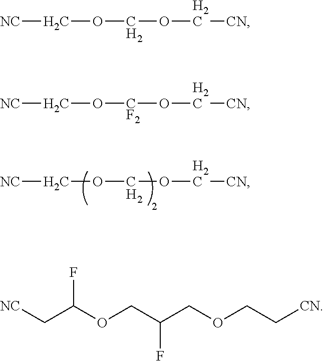

In the electrolyte, preferably, the content of the the dinitrile compounds containing ether bonds takes 0.01˜5% in the total weight of electrolyte, and further preferably, the content of the dinitrile compounds containing ether bonds takes 0.1˜3% in the total weight of electrolyte.

When the electrolyte contains carboxylate compound, fluoro-ether compound and the dinitrile compounds containing ether bonds, the application the electrolyte to the lithium-ion battery, particularly the irregular-shaped lithium-ion battery, can improve the high temperature storage performance, high temperature cycle life performance and rate capacity of the lithium-ion battery, particularly, the storage performance and cycle life performance of the ion battery at high temperature and voltage, as well as the rate capacity of the lithium-ion battery at high voltage.

Preferably, the additives in the electrolyte comprises at least one of the cyclic carbonate compound containing unsaturated carbon-carbon bonds, fluoro carbonic ester compound, and cyclic ester compound containing sulphur-oxygen double bonds; wherein in the cyclic carbonate compound containing unsaturated carbon-carbon bonds, the unsaturated carbon-carbon bond is preferably a double bond which can be either or not on the ring. The examples of the cyclic carbonate compound containing unsaturated carbon-carbon bonds are vinylene carbonate, and vinylethylene carbonate; and the examples of fluoro carbonate compound are fluorovinylene carbonate, 1,2-difluoro vinylene carbonate, and fluoroethylene carbonate.

Referably, the cyclic ester compound containing sulphur-oxygen double bonds is selected from at least one of cyclic suphate, cyclic sulphite, saturated sultone and unsaturated sultone. The examples of the compounds containging sulphure-oxygen double bonds are : vinyl sulphite, propyl sulphite, 1,3-propane sultone, 1,4-butyl sultone, 1,3-propylene sultone, 1,4-butylene sultone, 1-methyl -1,3-propylene sultone, vinylidene sulphite, and propylidene sulphite.

When the electrolyte comprises one or more of the the cyclic carbonate compound containing unsaturated carbon-carbon bonds, fluoro carbonate compound and cyclic ester compound containing sulphur-oxygen double bonds, the application of the electrolyte to the lithium-ion battery, particularly to the irregular-shaped lithium-ion battery, can further improve the high temperature storage performance, high temperature cycle life performance and rate capacity of the lithium-ion battery, particularly, the storage performance and cycle life performance of the ion battery at high temperature and voltage, as well as the rate capacity of the lithium-ion battery at high voltage.

Furthermore, the electrolyte further comprises one or more of the following compounds as the wetting additives:

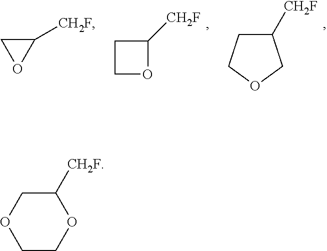

The content of the wetting additives takes preferably 0.01˜7% in the total weight of the electrolyte, particularly 0. 1˜5%.

When the electrolyte contains the fluoro cyclic ester compounds, the wettability of the electrolyte for the electrode sheets is improved, so as to enable the lithim-ion battery to have more excellent chemical performance, such as storage performance at high temperature and voltage, cycle life performance at high voltage and rate capacity.

In the electrolyte, preferably, the lithium salts are selected from at least one of the followings: lithium hexafluorophosphate, tetrafluoro-borate lithium, lithium hexafluoroarsenate, lithium perchlorate, lithium trifluorosulfonyl, lithium bis(trifluoromethylsulfonyl)imide, lithium bis(fluorosulfonyl)imide, and lithium tri(trifluoromethylsulfonyl)methyl; particularly, the density of lithium salts is 0.5 mol/L˜3 mol/L.

In the electrolyte, the non-aqueous organic solvent comprises at least one of the following: ethylene carbonate, propylene carbonate,dimethyl carbte, diethyl carbonate, ethyl methyl carbonate, γ-butyrolactone, methyl formate, ethyl formate, propyl formate, ethyl propionate, propyl propionate, butyl formate, butyl acetate, butyl propionate, butyl butyrate, and tetrahydrofuran.

Another object of the present disclosure is to provide a lithium-ion battery comprising a cathode sheet containing a positive active material, an anode sheet containing a negative active material, a lithium battery separator and an electrolyte, wherein the electrolyte is the electrolyte provided in the present disclosure.

The lithium-ion battery mentioned above particularly refers to an irregular shaped lithium-ion battery, which is a lithium-ion battery in an irregular shape, form example, the lithium-ion battery may be a ladder-shaped lithium-ion battery.

The kinds of the positive active materials and negative active materials in the electrolyte are not specifically limited, and are selectable according to requirements. Particularly, the positive active materials are selected from one or more of the lithium cobalt oxides and Li-NiCoMn material; the negative active materials are selected from one or more of graphite and silicon, wherein the silicon is selected from, but not limited to, one or more of nano-particles, silicon nanowire, silicon nanotube, silicon film, 3D porous silicon and hollow porous silicon.

In the above electrolyte, the kinds of lithium battery separators are not specifically limited, and are selected from, but not limited to, any lithium battery separator materials normally used in the lithium-ion battery, such as polyethylene, polypropylene, polyvinylidene fluoride and multilayer composite membrane of the polyethylene, polypropylene and polyvinylidenfluoride.

The preparation method for the lithium-ion battery provided in this disclosure is commonly known in the technical field, so the lithium-ion battery provided in this closure is capable of being prepared by the existing preparation method for the lithium-ion battery.

### Embodiments

The detailed description will be given of exemplary embodiments. But the following exemplary embodiments are considered as exemplary only, and the scope of the invention is not limited by them.

Without any explanation, the reagents, materials and instruments used in the embodiments, comparative examples and experimental examples are commercially purchasable.

In the embodiments, comparative examples and experimental examples, the following materials are used:

Organic solvent: ethylene carbonate (EC), diethyl carbonate (DEC)); carboxylic ester compounds (organic solvent A). The followings are the specific solvents:

A1: methyl acetate, A2: proply acetate, A3: 1-propylacetate, A4: 1-cyanopropyl acetate, A5: 1,4-butyrolactone, A6: 1,5-valerolactone;

Fluoro-ether compounds (additive B):

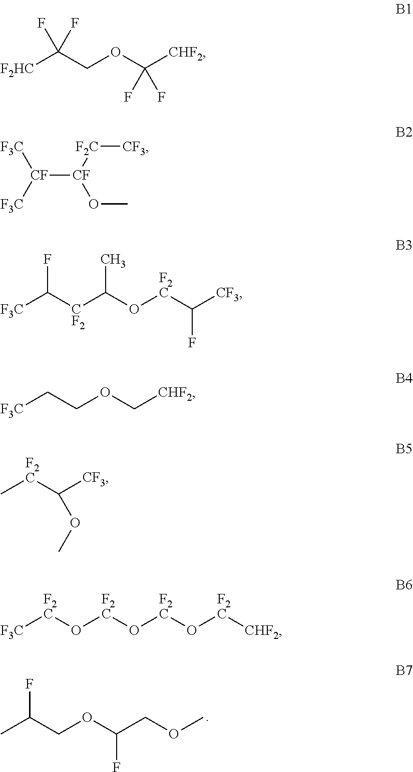

Dinitrile compounds comprising ether bonds (additive C):

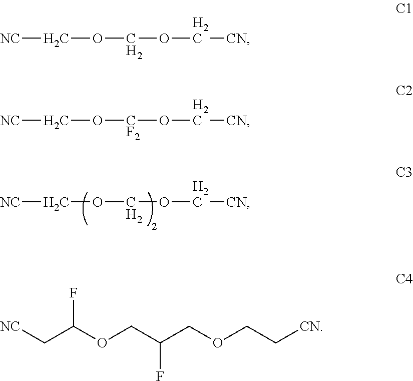

Other additives: vinylene carbonate (VC), propylene sulfite (PS), fluoro etheylene carbonate (FEC).

Lithium salt: LiPF₆.

Additive D:

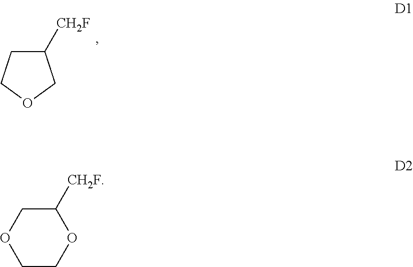

Lithium salt: LiPF₆.

Lithium battery separator: polypropylene separator in the thickness of 16 micrometers (type: A273, provided by Celgard Company).

### Embodiment 1˜17

### Preparation of Regular-shaped Lithium-ion Battery 1˜17 and Irregular-shaped Lithium-ion Battery S1˜S17

Regular-shaped lithium-ion batteries (hereinafter referred to as “battery” for short) 1˜17 and irregular-shaped lithium-ion batteries (hereinafter referred to as “battery” for short) S1˜S17 are prepared according to the following method:

(1) Preparing cathode sheet

Mix the lithium cobalt oxides (LiCoO₂), adhesive agent (polyvinylidene fluoride) and conductive agent (acetylene black) in a weight ratio of LiCoO₂: polyvinylidene fluoride: acetylene black=98:1:1 adding N-pyrrolidone (NMP) therein, and stir the mixture by the vacuum mixer until the mixture becomes uniform and transparent, thereby obtaining cathode slurry; coat the cathode slurry homogenously on the aluminum foil in the thickness of 12μm; dry the aluminum foil at room temperature and transfer it into the dryer for being dried at 120° C., and then cold press and slit it, so as to obtain the cathode.

(2) Preparing anode sheet

Mix the graphite, sodium carboxymethylcellulose (CMC) being thickener and butadiene styrene rubber being adhesive agent in a weight ratio of graphite: butadiene styrene rubber being adhesive agent : sodium carboxymethylcellulose (CMC) being thickener=98:1:1, add the mixture into deionized water, and stir it by vacuum mixer so as to obtain the anode slurry; coat the anode slurry homogeneously on the copper foil; dry the copper foil at room temperature and transfer it into the dryer for being dried at 120° C., and then cold press and slitit, so as to obtain the anode.

(3) Preparing Electrolyte

The electrolyte 1˜17 is prepared according to the following method:

In the drying room, homogenously mix the EC and DEC which have been rectified, dehydrated and purified to form a non-aqueous organic solvent, dissolve the fully dried lithium salts in the organic solvent, add carboxylic ester compound, fluoro-ether compound, dinitrile compounds having ether bonds, other additives and wetting additive into the organic solvent, mix them homogeneously, so as to obtain the electrolyte, wherein the concentration of the lithium salts is 1 mol/L, and the weight ratio of EC and DEC is EC: DEC=3:7.

(4) Preparing Lithium-ion Battery

The regular shaped lithium-ion battery is prepared according to the following method:

Laminate the cathode and anode which are normally slit, and the lithium battery separator in sequences, to make the lithium battery separator between the cathode and anode to function in separation, and wind them to obtain the naked cell; put the naked cell in the external package foil, inject the prepared electrolyte into the dried battery, and thereby obtaining the lithium-ion battery (hereinafter referred to as “battery” for short) by vacuum packaging, static keeping, formation and shaping processes.

The irregular shaped bettary S1˜S17 is prepared by the following method:

Repeat the preparation of the regular-shaped lithium-ion battery, wherein the cathode and anode are slit into the sheets in different sizes and shapes, and the slit cathode and anode and the lithium battery separator matching with the cathode and anode are laminated in sequence, and other processes are the same, thereby obtaining the lithium-ion battery in ladder shape (hereinafter referred to as “S” for short).

During preparing the battery, the kinds and contents of electrolyte in various battery and additives used in various electrolytes are listed in table 1 as below:

In table 1, the contents of the carboxylic ester compound, fluoro-ether compound, dinitrile compound having ether bonds, other additives and wetting additives are the weight percentage calculated based on the total weight of the electrolyte.

TABLE 1

| | | | | | | | | | Other | Additive |
|---|---|---|---|---|---|---|---|---|---|---|
| | | | Organic | | | | | | additive | D |
| Battery | Battery | Electrolyte | Solvent A | | Additive B | | Additive C | | Type and | Type and |
| No. | No. | No. | Type | Dosage | Type | Dosage | Type | Dosage | dosage | dosage |
| Battery1 | S1 | Electrolyte1 | A1 | 20% | B1 | 2% | C1 | 0.10% | -, 0% | -, 0% |
| Battery2 | S2 | Electrolyte2 | A1 | 20% | B1 | 2% | C1 | 1% | -, 0% | -, 0% |
| Battery3 | S3 | Electrolyte3 | A1 | 20% | B1 | 2% | C1 | 5% | VC + | -, 0% |
| | | | | | | | | | PS, 5% | |
| Battery4 | S4 | Electrolyte4 | A1 | 20% | B1 | 2% | C1 | 10% | -, 0% | -, 0% |
| Battery5 | S5 | Electrolyte5 | A3 | 20% | B1 | 1% | C1 | 1% | -, 0% | -, 0% |
| Battery6 | S6 | Electrolyte6 | A4 | 20% | B1 | 5% | C1 | 1% | -, 0% | -, 0% |
| Battery7 | S7 | Electrolyte7 | A1 | 20% | B1 | 10% | C1 | 1% | -, 0% | -, 0% |
| Battery8 | S8 | Electrolyte8 | A1 | 20% | B2 | 2% | C1 | 1% | VC + | -, 0% |
| | | | | | | | | | PS, 5% | |
| Battery9 | S9 | Electrolyte9 | A1 | 20% | B2 | 2% | C1 | 1% | -, 0% | -, 0% |
| Battery10 | S10 | Electrolyte10 | A1 | 20% | B2 | 2% | C2 | 1% | -, 0% | -, 0% |
| Battery11 | S11 | Electrolyte11 | A2 | 20% | B2 | 2% | C2 | 1% | -, 0% | -, 0% |
| Battery12 | S12 | Electrolyte12 | A5 | 20% | B5 | 2% | C2 | 1% | -, 0% | -, 0% |
| Battery13 | S13 | Electrolyte13 | A1 + A2 | 20% | B1 + B4 | 2% | C2 | 1% | -, 0% | -, 0% |
| Battery14 | S14 | Electrolyte14 | A1 | 25% | B6 | 3% | C3 | 2% | -, 0% | D1, 2% |
| Battery15 | S15 | Electrolyte15 | A5 | 30% | B3 | 4% | C1 | 3% | VC + | -, 0% |
| | | | | | | | | | PS, 5% | |
| Battery16 | S16 | Electrolyte16 | A6 | 20% | B7 | 2% | C4 | 4% | VC + | D2, 5% |
| | | | | | | | | | PS, 5% | |
| Battery17 | S17 | Electrolyte17 | A5 | 30% | B1 | 5% | C1 | 2% | FEC + | -, 0% |
| | | | | | | | | | PS, 5% | |

Note:
in table 1, VC weight:PS weight = 2:3, FEC weight:PS weight = 2:3, A1 weight:A2 weight = 2:1, B1 weight:B4 weight = 1:1, and“-”represents no substance to be selected.

### Comparative example

### the preparation of battery 1^{#}˜4^{#} and battery S1^{#}˜S4^{#}

Battery 1^{#}˜4^{#} and battery S1^{#l ˜S}4^{#} are prepared according to the following method:

Repeat the preparation of battery 1 and irregular-shaped battery S1, wherein the contents of organic solvent A, additive B and additive C in various batteries are changed, and other conditions are not changed.

During preparing the battery, the kinds and contents of electrolyte in various batteries and additives used in various electrolytes are listed in table 2 as below:

TABLE 2

| | | | | | | | | | Other | Additive |
|---|---|---|---|---|---|---|---|---|---|---|
| | | | Organic | | | | | | additive | D |
| Battery | Battery | Electrolyte | Solvent A | | Additive B | | Additive C | | Type and | Type and |
| No. | No. | No. | Type | Dosage | Type | Dosage | Type | Dosage | dosage | dosage |
| Battery | S1^{#} | Electrolyte | — | 0% | — | 0% | — | 0% | -, 0% | -, 0% |
| 1^{#} | | 1^{#} | | | | | | | | |
| Battery | S2^{#} | Electrolyte | A1 | 20% | — | 0% | — | 0% | VC + | -, 0% |
| 2^{#} | | 2^{#} | | | | | | | PS, 5% | |
| Battery | S3^{#} | Electrolyte | A1 | 20% | B1 | 2% | — | 0% | VC + | -, 0% |
| 3^{#} | | 3^{#} | | | | | | | PS, 5% | |
| Battery | S4^{#} | Electrolyte | A1 | 20% | — | 0% | C1 | 2% | VC + | -, 0% |
| 4^{#} | | 4^{#} | | | | | | | PS, 5% | |

Note:
in table 2, VC weight:PS weight = 2:3, and“-”represents no substance to be selected.

Performance Test

(1) Test on Wettability of Electrolyte

The wettability of the electrolyte prepared in the embodiments and comparative examples are tested by the following method: testing the surface tension of the electrolyte at 25□ through surface tension meter; testing the wetting time by dropping the electrolyte on the surface of the anode sheet and then testing the disappearance time of the electrolyte, the result of which is shown in table 3; wherein the smaller the surface tension is, the better the wettability is, and the shorter the disappearance time of the electrolytic time is, the better the wettability of the electrolyte is.

(2) Test on High Temperature Storage of Lithium-ion Batttery

The obtained batteries are respectively tested as below: statically keeping the battery for 30 minutes, charging it with constant currents at a rate of 0.5 C until the voltage reaches to 4.45V, and continuing charging it under constant voltage of 4.45V until the currents reach to 0.05 C; static keeping the battery for 5 minutes, then storing it at 60° C. for 4 hours, and finally testing the thickness expansion rate of the battery, the related results of which are shown in table 4, wherein the thickness expansion rate of the battery is calculated through the following formula:

thickness expansion rate=[(thickness after storage—thickness before storage)/thickness before storage]×100%.

(3) Test on Cycle life of Lithium-ion Battery at 45□

The obtained batteries are respectively tested as below: charging the battery with constant currents of 1 C at 45□ until voltage reaches to 4.45V, continuing the constant voltage charge until the currents reach to 0.05 C, and then discharging the battery with constant currents of 1 C until voltage reaches to 3V, which at this time constitutes the initial primary; repeating the battery circulation according to the previous conditions in multiple times, calculating the capacity retention rate of the battery after the circulation of 50 times, 100 times, 200 times and 300 times respectively, wherein the capacity retention rate after circulations is calculated according to the following formula and the results of the test are shown in table 4:

capacity retention rate after circulations=(discharge capacity corresponding to circulation/discharge capacity of the initial circulation) x100%.

It needs to be explained that in table 4, the mark [symbol] above the data of the thickness expansion rate and the capacity retention rate after circulations represents the data related to batteries 1˜17 and 1^{#}˜4^{#}, and [symbol] represents the data related to batteries S1˜S17 and S1^{#}S4^{#}

(4) Test on DC Internal Resistance of Lithium-ion Battery

The obtained batteries are respectively tested by the following method: discharging the battery with constant currents of 1 C at 25□ until the voltage reaches to 4.45V, then charging it at constant voltage of 4.45V until the currents<0.05 C, leaving the battery alone for 5 minutes, discharging the battery with constant currents of 1 C until the voltage reaches to 3V, recording the actual discharge capacity, adjusting the actual capacity of the battery to be 50% of the full charge capacity, discharging battery continuously with the currents of 0.3 C for 10 s (0.3 C-10 s), dividing the difference between the voltage before discharge and the voltage when discharge terminates by the currents to obtain the DC internal resistance (DCIR) (adopting the average value of the test results of 15 batteries), wherein the test data of the DCIR is shown in table 5.

(5) Test on Rate Capacity of Lithium-ion Battery

The obtained batteries are respectively tested by the following method: discharging the battery with the constant currents of 0.5 C until the voltage reaches to 3.0V, leaving the battery alone for 5 minutes, charging the battery with the constant currents of 0.5 C until the voltage reaches to 4.45V, continuing charging the battery with the constant voltage until the currents reach to 0.05 C, static keeping the battery for 5 minutes, and then discharging the battery with constant currents of respective 0.2 C, 0.5 C, 1 C, 2 C and 3 C until the voltage reaches to 3.0V; recording the discharge capacity under the conditions of 0.2 C, 0.5 C, 1 C, 2 C and 3 C, and calculating the discharge capacity retentation rate at different rates based on the discharge capacity under 0.2 C (adopting the average value of the test results of 15 batteries), wherein the related data is shown in table 5.

It needs to be explained that in table 5, the mark [symbol] above the data of the DCIR of 50% of full charge capacity and discharge capacity retention rates at different rates represents the data related to batteries 1˜17 and 1^{#}˜4^{#}, and [symbol] represents the data related to batteries S1˜S17 and S1^{#}˜S4^{#}.

TABLE 3

| | Surface | |
|---|---|---|
| Electrolyte | tension | |
| No. | mN/m | Wetting time/S |
| Electrolyte 1 | 23.1 | 55 |
| Electrolyte 2 | 16.6 | 50 |
| Electrolyte 3 | 15.5 | 44 |
| Electrolyte 4 | 19.3 | 55 |
| Electrolyte 5 | 18.9 | 52 |
| Electrolyte 6 | 18.5 | 51 |
| Electrolyte 7 | 17.8 | 45 |
| Electrolyte 8 | 13.6 | 42 |
| Electrolyte 9 | 17.9 | 54 |
| Electrolyte 10 | 21.7 | 57 |
| Electrolyte 11 | 22.8 | 52 |
| Electrolyte 12 | 18.3 | 49 |
| Electrolyte 13 | 20.6 | 55 |
| Electrolyte 14 | 18.9 | 52 |
| Electrolyte 15 | 14.5 | 43 |
| Electrolyte 16 | 12.1 | 38 |
| Electrolyte 17 | 13.3 | 40 |
| Electrolyte 1^{#} | 80.6 | 130 |
| Electrolyte 2^{#} | 45.6 | 74 |
| Electrolyte 3^{#} | 40.5 | 70 |
| Electrolyte 4^{#} | 42.9 | 68 |

As seen from the relevant data in table 3, electrolytes 1˜17 have relatively low surface tension and short wetting time as compared with the electrolytes 1^{#}˜4^{#}, the electrolyte provided by the present disclosure has an excellent wettability.

TABLE 4

| | | Thickness | | Capacity retention rate after n times of circulation at 45° C. | | | | | | | |
|---|---|---|---|---|---|---|---|---|---|---|---|
| | | expansion | | (%) | | | | | | | |
| | | rate/% | | 50 times | | 100 times | | 200 times | | 300 times | |
| \textcircled{1} | \textcircled{2} | \textcircled{1} | \textcircled{2} | \textcircled{1} | \textcircled{2} | \textcircled{1} | \textcircled{2} | \textcircled{1} | \textcircled{2} | \textcircled{1} | \textcircled{2} |
| Battery1 | S1 | 6.3 | 5.3 | 95.5 | 94.3 | 93.6 | 92.4 | 90.7 | 89.5 | 88.3 | 87.1 |
| Battery2 | S2 | 5.8 | 4.8 | 95.7 | 94.8 | 93.5 | 92.6 | 90.6 | 89.7 | 88.2 | 87.3 |
| Battery3 | S3 | 5.7 | 4.7 | 95.9 | 95.1 | 94 | 93.2 | 91.1 | 90.3 | 88.8 | 88 |
| Battery4 | S4 | 5 | 4 | 94.2 | 93.4 | 91.9 | 91.1 | 88.6 | 87.8 | 86.9 | 86.1 |
| Battery5 | S5 | 6.8 | 5.8 | 93.2 | 92.4 | 91.1 | 90.3 | 88.2 | 87.4 | 85.9 | 85.1 |
| Battery6 | S6 | 7.4 | 6.4 | 93.3 | 92.5 | 91.6 | 90.8 | 88.2 | 87.4 | 85.9 | 85.1 |
| Battery7 | S7 | 6.8 | 5.8 | 95.9 | 95.1 | 94.5 | 93.7 | 91.3 | 90.5 | 89.2 | 88.4 |
| Battery8 | S8 | 5.6 | 4.6 | 96.8 | 96.3 | 95.3 | 94.5 | 93.8 | 92.1 | 91.8 | 90.5 |
| Battery9 | S9 | 6.5 | 5.5 | 93.3 | 92.5 | 90.5 | 89.7 | 87.9 | 87.1 | 84.2 | 83.4 |
| Battery10 | S10 | 6.3 | 5.3 | 91.9 | 91.1 | 89.1 | 88.3 | 86.3 | 85.5 | 83.6 | 82.8 |
| Battery11 | S11 | 5.9 | 4.9 | 94.6 | 93.8 | 93.3 | 92.5 | 90.4 | 89.6 | 87.6 | 86.8 |
| Battery12 | S12 | 5.3 | 4.3 | 95 | 94.2 | 92.9 | 92.1 | 89.9 | 89.1 | 88.3 | 87.5 |
| Battery13 | S13 | 6.8 | 5.8 | 94.8 | 94 | 93 | 92.2 | 90.4 | 89.6 | 88.2 | 87.4 |
| Battery14 | S14 | 6.5 | 5.5 | 95.1 | 94.5 | 93.8 | 92.8 | 91.1 | 90.7 | 89.4 | 88.3 |
| Battery15 | S15 | 6.1 | 5.2 | 95.7 | 95.1 | 94.2 | −93.6 | 92.8 | 91.1 | 90.5 | 89.8 |
| Battery16 | S16 | 5.1 | 4.2 | 97.9 | 96.8 | 95.4 | 94.7 | 93.9 | 92.6 | 91.6 | 90.9 |
| Battery17 | S17 | 5.8 | 4.6 | 96.9 | 96.4 | 95.1 | 94.2 | 93.2 | 91.8 | 91.1 | 90.3 |
| Battery1^{#} | S1^{#} | 23.5 | 22 | 91.7 | 81.4 | 86.9 | 76.6 | 81.3 | 71 | 76.5 | 66.2 |
| Battery2^{#} | S2^{#} | 40.2 | 43.2 | 90.5 | 80.2 | 84.5 | 74.2 | 77.8 | 67.5 | 71.4 | 61.1 |
| Battery3^{#} | S3^{#} | 16.5 | 15.5 | 92 | 81.7 | 86 | 75.7 | 79.3 | 69 | 72.9 | 62.6 |
| Battery4^{#} | S4^{#} | 23.2 | 22.9 | 90.6 | 80.3 | 84.6 | 74.3 | 77.9 | 67.6 | 71.5 | 61.2 |

As seen from the relevant date in table 4, as compared with batteries 1˜4 and S1^{#}˜S4^{#}, batteries 1˜17 and S1˜S17 have relatively low thickness expansion rate and relatively high capacity retention rate tested after storing the batteries in full charge for 4 hours at 60□ and cycle life the batteries in 50, 100, 200 and 300 times.

In view of the above, the application of the electrolyte provided by the disclosure to the lithium-ion battery is capable of improving the storage performance and cycle life performance of the regular and irregular shape batteries, specifically the storage performance of the batteries at the high voltage of above 4.45V at 60□ and the cycle life performance of the batteries at the high voltage of above 4.45V at 45□, and in particularly the storage performance and cycle life performance of the ladder shaped batteries at high temperature and voltage.

TABLE 5

| | | 50% of the | | | | | | | | | |
|---|---|---|---|---|---|---|---|---|---|---|---|
| | | full charge | | | | | | | | | |
| | | capacity | | | | | | | | | |
| | | DCIR | | Discharge capacity retension rate of different rate capacity/% | | | | | | | |
| | | (mohm) | | 0.5 C | | 1 C | | 2 C | | 3 C | |
| \textcircled{1} | \textcircled{2} | \textcircled{1} | \textcircled{2} | \textcircled{1} | \textcircled{2} | \textcircled{1} | \textcircled{2} | \textcircled{1} | \textcircled{2} | \textcircled{1} | \textcircled{2} |
| Battery1 | S1 | 56.6 | 43.2 | 95.4 | 96.3 | 88.6 | 89.6 | 77.9 | 79.9 | 67.2 | 68.1 |
| Battery2 | S2 | 52.4 | 41.5 | 94.9 | 95.8 | 87.5 | 88.1 | 76.5 | 78.6 | 66.9 | 67.9 |
| Battery3 | S3 | 45.3 | 35.5 | 96.3 | 96.1 | 88.9 | 88.9 | 78.3 | 78.7 | 67.3 | 67.8 |
| Battery4 | S4 | 50.5 | 38.6 | 94.3 | 94.8 | 87.6 | 88.6 | 76.9 | 77.9 | 66.9 | 68.9 |
| Battery5 | S5 | 51.8 | 45.6 | 93.8 | 95.9 | 85.3 | 87.3 | 76.2 | 77.2 | 65.8 | 66.2 |
| Battery6 | S6 | 50.9 | 43.4 | 95.2 | 95.7 | 86.2 | 87.3 | 75.9 | 78.1 | 67.1 | 67.3 |
| Battery7 | S7 | 55.9 | 42.1 | 96.1 | 96.4 | 84.9 | 85.5 | 74.6 | 78.6 | 66.3 | 66.8 |
| Battery8 | S8 | 54.3 | 33.8 | 94.5 | 97.2 | 84.3 | 93.1 | 73.5 | 90.5 | 65.6 | 87.6 |
| Battery9 | S9 | 51.2 | 42.2 | 93.9 | 94.7 | 85.1 | 86.3 | 74.1 | 74.9 | 64.9 | 66.9 |
| Battery10 | S10 | 59.8 | 46.2 | 94.2 | 94.9 | 84.9 | 85.3 | 75.2 | 76.4 | 65.1 | 67.5 |
| Battery11 | S11 | 55.2 | 45.1 | 95.6 | 95.8 | 86.3 | 86.1 | 75.0 | 76.3 | 66.2 | 67.2 |
| Battery12 | S12 | 58.4 | 46.1 | 92.8 | 93.8 | 85.3 | 85.8 | 75.3 | 77.3 | 65.8 | 66.8 |
| Battery13 | S13 | 57.2 | 47.3 | 92.1 | 92.6 | 85.9 | 86.2 | 74.6 | 76.3 | 65.2 | 65.7 |
| Battery14 | S14 | 56.7 | 45.3 | 93.2 | 93.1 | 88.6 | 87.7 | 75.5 | 77.8 | 67.9 | 68.4 |
| Battery15 | S15 | 54.2 | 38.9 | 94.4 | 93.7 | 89.7 | 88.5 | 76.5 | 78.6 | 68.3 | 69.8 |
| Battery16 | S16 | 51.5 | 30.6 | 96.4 | 97.8 | 88.5 | 94.5 | 77.3 | 91.3 | 66.6 | 88.3 |
| Battery17 | S17 | 53.5 | 32.4 | 95.1 | 97.3 | 86.5 | 94.1 | 75.2 | 90.8 | 65.9 | 87.9 |
| Battery1^{#} | S1^{#} | 110.2 | 145.2 | 83.5 | 81.7 | 73.2 | 71.2 | 67.5 | 64.5 | 57.6 | 55.6 |
| Battery2^{#} | S2^{#} | 124.8 | 165.2 | 82.3 | 80.3 | 70.5 | 69.5 | 62.7 | 60.7 | 55.3 | 53.3 |
| Battery3^{#} | S3^{#} | 109.4 | 134.7 | 85.6 | 80.6 | 72.4 | 70.4 | 65.4 | 64.4 | 56.2 | 54.2 |
| Battery4^{#} | S4^{#} | 103.7 | 142.5 | 84.1 | 81.1 | 71.5 | 71.3 | 64.3 | 63.3 | 55.1 | 54.1 |

As seen from the relevant data of table 5, as compared with batteries 1˜4 and S1^{#}˜S4^{#}, batteries 1˜17 and S1˜S17 have relatively low DC internal resistance and relatively high capacity retention rate obtained by both the DC internal resistance test and the respective test at different rates of 0.2 C, 0.5 C, 1 C, 2 C and 3 C.

As seen from the above, the application of the electrolyte provided in this disclosure to the lithium-ion battery improves the rate capacity of the battery in both regular and irregular shapes.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. An electrolyte, wherein the electrolyte comprising: lithium salt, a non-aqueous organic solvent and additives, wherein the non-aqueous organic solvent comprises a carboxylate compound, and the additives comprise a fluoroether compound and a dinitrile compound comprising an ether bond.

2. The electrolyte according to claim 1, wherein the carboxylate compound is selected from one or more of the compounds represented in the following formulas I, II, III and IV: 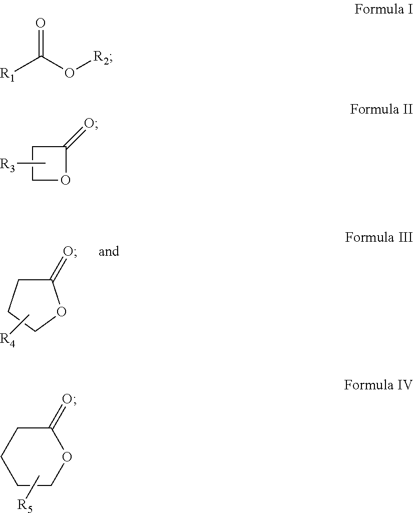
wherein, R₁, R₂, R₃, R₄, and R₅ are respectively selected from one of a hydrogen atom, a halogen atom, a cyano-group, an alkyl having 1˜20 carbon atom(s), an alkenyl having 2˜20 carbon atoms, an aryl having 6˜26 carbon atoms, a group containing oxygen atoms in the alkyl having 1˜20 carbon atom(s), the alkenyl having 2˜20 carbon atoms and the aryl having 6˜26 carbon atoms, and a group formed by substituting the alky having 1˜20 carbon atom(s), the alkenyl having 2˜20 carbon atoms and the aryl having 6˜26 carbon atoms with a halogen atom or a cyano group, wherein the halogen atom is F, Cl and Br, and neither R₁ and R₂ is a hydrogen atom, a halogen atom or a cyano group.

3. The electrolyte according to claim 2, wherein R₁, R₂, R₃, R₄ and R₅ are respectively selected from one of a chain alkyl containing 1˜6 carbon atom(s), a naphthenic containing 3˜8 carbon atoms, an alkenyl having 2˜6 carbon atoms, an aryl having 6˜14 carbon atoms, an alkoxyl having 1˜6 carbon atom(s), an alkyl ether having 2˜6 carbon atoms, an alkenyloxy having 2˜8 carbon atoms, an alkenyl ether having 3˜8 carbon atoms, an aryloxy having 6˜14 carbon atoms, an arylether having 7˜14 carbon atoms, a halogenated chain alkyl having 1˜6 carbon atom(s), a halogenated naphthene having 3˜8 carbon atoms, a halogenated alkenyl having 2˜6 carbon atoms, a halogenated aryl having 6˜14 carbon atoms, a chain alkyl cyano group having 2˜6 carbon atoms, and a naphthene cyano group having 4˜8 carbon atoms.

4. The electrolyte according to claim 1, wherein the fluoro-ether compound is selected from one or more of the compounds represented by the following formulas V and VI: 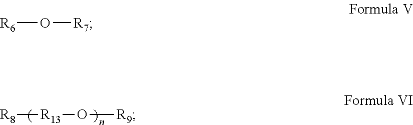
wherein, R₆ and R₇ are respectively selected from one of a fluoro alkyl having 1˜20 carbon atom(s), a fluoro alkenyl having 2˜20 carbon atoms, and a fluoro aryl having 6˜22 carbon atoms; and
R_{g} and R₉ are respectively selected from one of an alkyl having 1˜10 carbon atom(s), an alkenyl having 2˜10 carbon atoms, an aryl having 6˜14 carbon atoms, a fluoro alkyl having 1˜10 carbon atom(s), a fluoro alkenyl having 2˜10 carbon atoms and a fluoro-aryl having 6˜14 carbon atoms, R₁₃ is selected from one of a fluoroalkylene having 1˜20 carbon atom(s), a fluoro alkenylene having 2˜20 carbon atoms and a fluoro arylidene having 6˜22 carbon atoms, and n is an integer between 2˜10.

5. The electrolyte according to claim 4, wherein:
R₆ and R₇ are respectively selected from a fluoro chain alkyl having 1˜6 carbon atom(s), a fluoro naphthene having 3˜8 carbon atoms, a fluoro alkenyl having 2˜6 carbon atoms and a fluoro aryl having 6˜14 carbon atoms;
R₈ and R₉ are respectively selected from one of a chain alkyl having 1˜6 carbon atom(s), a naphthene having 3˜8 carbon atoms, an alkenyl having 2˜6 carbon atoms, an aryl having 6˜10 carbon atoms, a fluoro chain alkyl group having 1˜6 carbon atom(s), a fluoro naphthene having 3˜8 carbon atoms, a fluoro alkenyl having 2˜6 carbon atoms and a fluoro aryl having 6˜10 carbon atoms, and R₁₃ is selected from one of a chain fluoro alkylene having 1˜6 carbon atom(s), a fluoro cyclic alkylene having 3˜8 carbon atoms, a fluoro alkenylene having 2˜8 carbon atoms and a fluoron arylidene having 6˜12 carbon atoms.

6. The electrolyte according to claim 1, wherein the dinitrile compound comprising an ether bond is selected from one or more of compounds represented by the following formula VII: 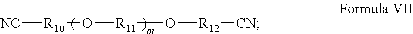
wherein, R₁₀, R₁₁ and R₁₂ are respectively selected from one of an alkylene having 1˜10 carbon atom(s), an alkenylene group having 2˜10 carbon atoms, and a fluoro alkylene group having 1˜10 carbon atom(s), and m is an integer between 1˜10.

7. The electrolyte according to claim 6, wherein R₁₀, R₁₁ and R₁₂ are respectively selected from one of a chain alkylene group having 1˜6 carbon atom(s), a cyclic alkylene group having 3˜8 carbon atoms, an alkenylene group having 2˜6 carbon atoms, a chain fluoro alkylene group having 1˜6 carbon atom(s), and a fluoro cyclic alkylene group having 3˜8 carbon atoms.

8. The electrolyte according to claim 1, wherein the content of the carboxylate compound takes 1˜70% in the total weight of the electrolyte, the content of the fluoroether compound takes 0.01˜5% in the total weight of the electrolyte, and the content of the dinitrile compound comprising an ether bond takes 0.01˜5% in the total weight of the electrolyte.

9. The electrolyte according to claim 1, wherein:
the additive further comprises at least one of a cyclic carbonate compound containing an unsaturated carbon-carbon bond, a fluorocarbonate compound, and a cyclic ester compound containing at least a sulphur-oxygen double bond;
the lithium salt is selected from one or more of lithium hexafluorophosphate, lithium tetrafluoroborate, lithium hexafluoroarsenate, lithium perchlorate, lithium trifluorosulfonyl, lithium bis(trifluoromethylsulfonyl)imide, lithium bis(fluorosulfonyl)imide, lithium tri(trifluoromethylsulfonyl)methyl; and
the non-aqueous organic solvent comprises one or more of ethylene carbonate, propylene carbonate, dimethyl carbonate, diethyl carbonate, ethyl methyl carbonate,γ-butyrolactone, methyl formate, ethyl formate, propyl formate, ethyl propionate, propyl propionate, butyl formate, butyl acetate, butyl propionic acid, butyl propionate, butyl butyrate and tetrahydrofuran.

10. A lithium-ion battery, wherein the lithium-ion battery comprising acathode sheet containing a positive active material, an anode sheet containing a negative active material, a lithium battery separator and the electrolyte according to claim 1.
